(19) United States
(12) Patent Application Publication
(10) Pub. No.: US 2007/0228070 A1
(43) Pub. Date: Oct. 4, 2007

(54) Dispenser

(76) Inventor: Stuart J. Dobson, Gauteng Province (ZA)

Correspondence Address: DARBY & DARBY P.C., P.O. BOX 770, Church Street Station, New York, NY, 10008-0770, US

(21) Appl. No.: 11/575,559

(22) PCT Filed: Sep. 19, 2005
(86) PCT No.: PCT/IB05/02774

§ 371 Date: Mar. 19, 2007

(30) Foreign Application Priority Data
Sep. 19, 2004 (ZA) 2004/2213

(51) Int. Cl. B67D 5/00

(52) U.S. Cl. 222/21

(57) ABSTRACT

This invention provides a dispenser for storing and dispensing a flowable composition, such as sugar, comprising a receptacle having a first outlet and a second outlet and a pair of measuring containers of predetermined volume within the receptacle, the containers having an inlet into the interior of the receptacle and an outlet alignable to an outlet from the receptacle.

### FIELD OF THE INVENTION

The present invention relates to a dispenser, more particularly a disposable dispenser for receiving, storing and dispensing a flowable composition. Still more particularly, the invention relates to a sugar dispenser for domestic use.

### BACKGROUND TO THE INVENTION

Generally, flowable compositions such as sugar, flour, washing powder and other domestic consumables are sold in large bags in which they are stored and from which they are dispensed. These bags often do not facilitate the dispensing of the compositions in convenient amounts for domestic use and, as they may be unsightly, the bags themselves are usually stored out of sight in a cupboard or pantry where they tend to attract household pests.

There are a number of dispensers for flowable compositions for domestic use but these dispensers are, as a rule, not adapted for storing the compositions. Consequently they hold a small quantity of the composition and must be refilled regularly. This is usually inconvenient and, because of the nature of the bags in which such compositions are usually stored, filling the dispensers tends to be messy and the mess also attracts household pests.

There are some dispensers which exist, particularly for sugar, which have a smaller tube of predetermined volume inside which permits the predetermined volume to be dispensed. Such dispensers usually require the entire dispenser to be turned around which often leads to inaccurate dispensing. Also, although this is an effective means for dispensing one measured volume, it is sometimes faster and hence more convenient to simply use a spoon when several volumes are needed, especially when the dispenser is full and accordingly heavy.

Another problem with existing dispensers is that they often do not allow for the dispensing of an unmeasured volume.

### OBJECT OF THE INVENTION

It is an object of the invention to provide a dispenser which at least partly alleviates the abovementioned problems, particularly a disposable dispenser for receiving, storing and dispensing a flowable composition.

### SUMMARY OF THE INVENTION

In accordance with this invention there is provided a dispenser for storing and dispensing a flowable composition, comprising

a receptacle having a first outlet and a second outlet and

a measuring container of predetermined volume within the receptacle,

the container being movable relative to the receptacle between a receiving condition in which the container inlet is open into the receptacle and the container outlet is not aligned with the second receptacle outlet, and a dispensing condition in which the container inlet is closed and the container outlet is aligned with the second receptacle outlet.

Further in accordance with the invention there is provided for the measuring container to be separate and attachable to the receptacle.

Still further in accordance with the invention there is provided for there to be a pair of measuring containers having outlets separately alignable to the receptacle outlet.

Yet further in accordance with the invention there is provided for the containers to be provided in a single body movable in the receptacle to bring either or neither of the container outlets into alignment with the receptacle outlet.

There is further provided for the body to extend slidably through opposite walls of the receptacle with the containers being open ended tubes extending through the body.

There is also provided for the dispenser to be fabricated from a transparent, translucent or opaque synthetic plastics material; from a metal, preferably a metal alloy; from a transparent, translucent or opaque glass; or from a fibrous material such as a board.

There is also provided for the receptacle to be in any one of a number of different shapes for example, generally spherical, cuboidal, or tubular.

There is further provided for the first outlet of the receptacle to have a lid which is movable between an open position and a closed position, for the lid to be hinged at one end, alternatively for the lid to be slidable between its open and closed positions.

There is also provided for the dispenser to be disposable. Alternatively, the dispenser may be reusable.

There is yet further provided for dispensing guides to extend from the receptacle around the second outlet.

### BRIEF DESCRIPTION OF THE DRAWING

One embodiment of the invention will be described below by way of example only and with reference to the accompanying drawings in which

FIG. 1 is a perspective view of a dispenser for storing and dispensing a flowable composition according to the invention;

FIG. 2 is a perspective view of the dispenser in FIG. 1 having a top section cut away; and

FIG. 3 is a perspective view of the dispenser in FIG. 1 is a disassembled state.

### DETAILED DESCRIPTION OF THE INVENTION

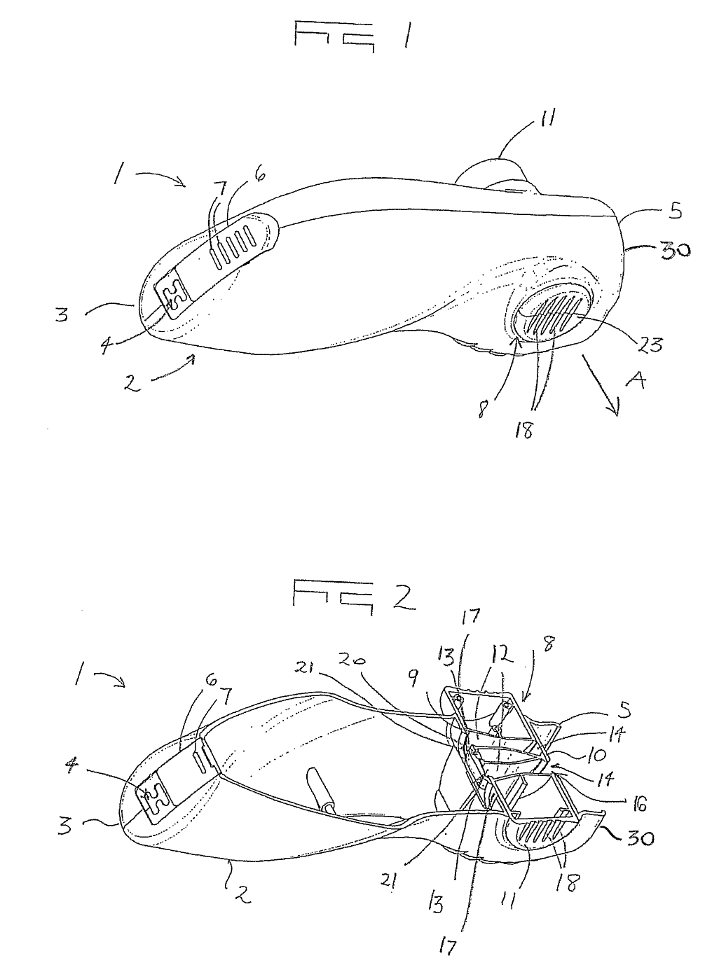

Referring to FIG. 1, a dispenser (1) for storing and dispensing a flowable composition, such as sugar, is shown and includes an elongate, substantially cylindrical receptacle (2) which tapers at one end (3). The receptacle has one first H shaped outlet (4) on its tapering side (3) and a flat base (5) on the opposite side. Accordingly, the dispenser (1) shown in FIG. 1 is shown on its side and not in an upright position. In this embodiment, the first outlet (4) may be covered by way of a substantially rectangular lid (6) which is slidable over the outlet (4). The lid (6) has five friction affording protuberances (7) formed on its surface.

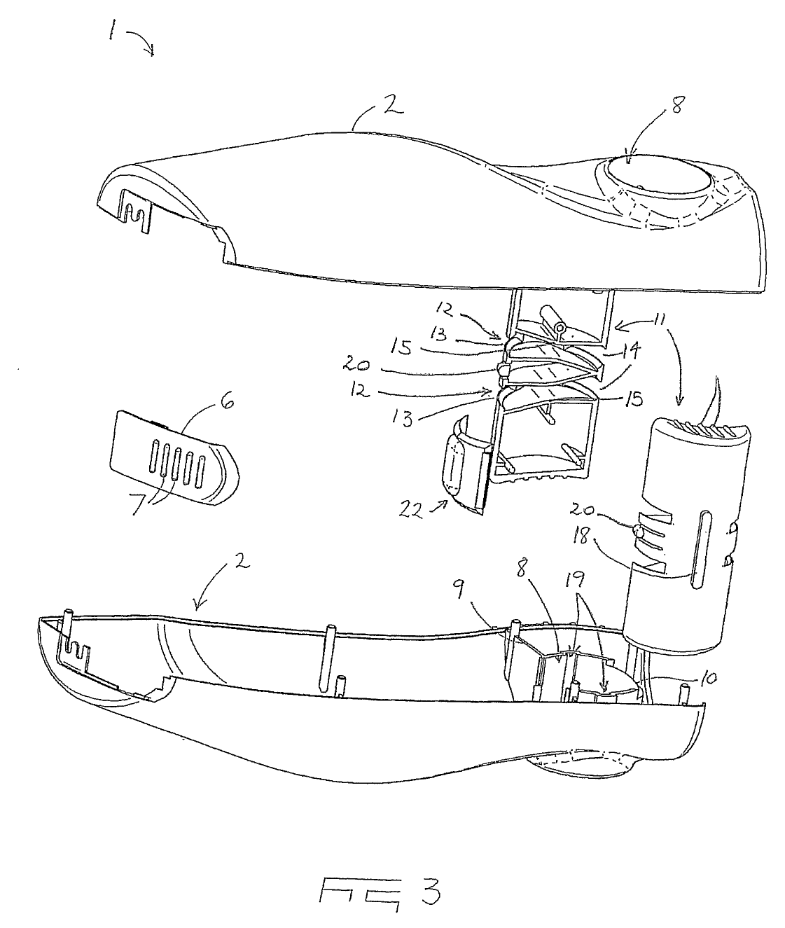

As shown in FIGS. 2 and 3, a cylindrical cavity (8) is defined by two arcuate dividers (9; 10) near the base (5) of the receptacle (2) and extends through the sidewalls of the receptacle (2). A separate cylindrical body (11) is complementarily shaped and dimensioned to be received inside the cavity (8). Two spaced elongate grooves (12) of predetermined volume extend through the diameter of the cylindrical body (11). When the cylindrical body is positioned inside the cavity (8), a pair of measuring containers (12) of predetermined volume, such as five millilitres, are formed, partly by cylindrical body (11) and partly by the dividers (9; 10). Each container (12) has an inlet (13) and an outlet (14) and gradually narrows towards the middle to form a waist (15).

The innermost arcuate divider (9) has two parallel openings (17) extending therethrough which are complementarily shaped to the inlets (13) of the containers (12) on the cylindrical body (11). The outermost divider (10) similarly has one complementarily shaped opening (16) extending therethrough, thereby defining a second outlet (16) in the receptacle (2). Each container (12) accordingly has a refilling condition, in which its inlet (13) is aligned with the opening (17) and its outlet (14) is not aligned with the second outlet (16), and a dispensing condition, in which the inlet (17) is not aligned with the opening (17) and the outlet is aligned with the second receptacle outlet (16).

As can be seen in FIG. 3, the cylindrical body (11) has two longitudinal ribs (18) extending centrally partway along its length, on diametrically opposite sides of the body (11). Each rib (18) fits inside a complementary guide slot (19) in each arcuate divider (9; 10). The slots (19) are longer than the rib (18) so that the ribs are permitted to slide thereinside. In between the two containers (12) on the cylindrical body (11) there is a rounded detent (20) extending partway along its circumference. This detent (20) is movable between two spaced spherical slits (21) in a separate holding member (22) attached to the innermost divider (9), thereby securing the cylindrical body (11) in one of two conditions.

The cylindrical body (11) also has five friction affording protuberances extending along the surface of its two ends (23) to increase the friction thereon.

A circular guide wall extends from the receptacle wall around the second outlet (14).

In use, the dispenser (1) is stored in an upright position, so that its contents, such as sugar, flows into the containers (12) which is in a refilling condition. A user who wishes to use an indeterminate amount of sugar may open the H shaped inlet (4) by sliding the lid (6) away from it and dispensing the desired volume of sugar therefrom. A user who instead wishes to use a measured volume of sugar, for example in a drink, can locate the receptacle within the guide walls, and move the cylindrical body (11) in the direction of arrow A in FIG. 1. The force exerted by the user urges the detent (20) out of one slit (21) into the other slit, so that the container (12) is moved to a dispensing condition. The volume of sugar thus contained in the container (12) is dispensed. Because of the detent (20) which is secured inside the slits (21), the cylindrical body (11) is prevented from freely sliding inside the receptacle (2). Meanwhile, the adjacent container (12) is moved to the refilling condition as its inlet (13) aligns with the opening (16) in the innermost divider (9) and it is in flow communication with the interior of the receptacle (2). If he wishes to dispense a second volume of sugar, the user can then push the cylindrical body (11) longitudinally again.

In this embodiment, the dispenser (1) is fabricated from a transparent, translucent or opaque synthetic plastics material. The receptacle and cylindrical body are manufactured by an injection moulding process in two cooperating parts which are then joined together. The lid and holding member are manufactured separately. It will be readily appreciated it may be manufactured from a metal, preferably a metal alloy; from a transparent, translucent or opaque glass; or from a fibrous material such as a board.

The dispenser may have any one of a number of different shapes for example, generally spherical, cuboidal, or tubular.

It will be appreciated that many of this embodiments of a dispenser exist which fall within the scope of the invention. For example, the dispenser (1) may have a measuring container which is in the form of a funnel formed inside the receptacle (2). When the dispenser (1) is in an upright condition, the funnel has its funnel or wide end in close proximity to the base (5) of the and narrow end is in register with the second aperture (6). Also, while in this embodiment the dispenser (1) is disposable, it is possible to have a reusable dispenser. Then, there may be a larger third aperture which may be used for refilling purposes.

In this specification, the term “flowable composition” will be interpreted widely and includes a flowable powder, for example, baking powder, powdered milk or washing powder; a flowable crystalline composition, for example, sugar or salt; a flowable granular composition, for example, instant coffee granules, fertilizer or granulated washing powder; a comminuted biological material, for example herbs and/or spices; and any combination of the above.

It will readily be appreciated that this invention provides a dispenser for receiving, storing and dispensing a flowable composition which is more sightly than existing large volume dispensers. It also allows a user to dispense an unmeasured volume of its contents. Movement of the container is further simple enough to carry out with one hand and relatively more accurate dispensing is permitted since the container does not need to be turned around.

1. A dispenser for storing and dispensing a flowable composition, comprising
a receptacle having a first outlet and a second outlet and
a measuring container of predetermined volume within the receptacle,
the container being slidably movable relative to the receptacle between a receiving condition in which the container inlet is open into the receptacle and the container outlet is not aligned with the second receptacle outlet, and a dispensing condition in which the container inlet is closed and the container outlet is aligned with the second receptacle outlet.

2. The dispenser as claimed in claim 1, in which the measuring container is separate and attachable to the receptacle.

3. The dispenser as claimed in claim 1, having a pair of measuring containers, spaced along the direction of slide, having outlets separately alignable to the receptacle outlet.

4. The dispenser as claimed in claim 3 in which the containers are provided on a single movable body in the receptacle to bring either or neither of the container outlets into alignment with the receptacle outlet.

5. The dispenser as claimed in claim 4, in which the body extends slidably through opposite walls of the receptacle with the containers being open ended tubes extending through the body.

6. The dispenser as claimed in claim 1, in which the measuring container is a funnel having its funnel or wide end in close proximity to the base of the receptacle and its outlet or narrow end in register with the receptacle outlet.

7. The dispenser as claimed in claim 1, in which the or each aperture on the receptacle has a lid which is movable between an open position and a closed position.

8. The dispenser as claimed in claim 1, being a disposable dispenser.

9. The dispenser as claimed in claim 1, being a reusable dispenser.

10. The dispenser as claimed in claim 1, in which dispensing guides extend from the receptacle around the second outlet.
